(19) United States
(12) Patent Application Publication
(10) Pub. No.: US 2004/0191389 A1
(43) Pub. Date: Sep. 30, 2004

(54) Manipulation of chocolate flavor

(76) Inventors: Sunil Kochhar, Savigny (CH); Christopher Budwig, Dublin, OH (US); Carl Erik Hansen, Epalinges (CH); Marcel Alexandre Juillerat, Lausanne (CH); Jean-Claude Spadone, La Tour-De-Peilz (CH); Pierre Nicolas, Saint-Legier (CH); Robert Redgwell, Savigny (CH); Euan Armstrong, Pasadena (US); Dietmar Sievert, Epalinges (CH)

Correspondence Address: WINSTON & STRAWN, PATENT DEPARTMENT, 1400 L STREET, N.W., WASHINGTON, DC, 20005-3502, US

(21) Appl. No.: 10/819,180

(22) Filed: Apr. 7, 2004

Related U.S. Application Data
(63) Continuation of application No. PCT/EP02/07055, filed on Jun. 25, 2002.

(30) Foreign Application Priority Data
Oct. 30, 2001 (EP) 0126025.6

(51) Int. Cl. A23G 1/00

(52) U.S. Cl. 426/593

(57) ABSTRACT

A process for manipulating the flavor of a single mass of chocolate which comprises first reducing or removing the natural flavor from the chocolate ingredients or the chocolate mass and then adding an effective amount of a flavor to the chocolate mass. The flavor provides any of the following attributes: cocoa/dairy, roasted, sweet, bitter, crumb, caramel, fruity, floral, biscuit, baked, bready, cereal, malty, popcorn, astringent or praline.

### CROSS-REFERENCE TO RELATED APPLICATIONS

This application is a continuation of International Application PCT/EP02/07055 filed Jun. 25, 2002, the entire content of which is expressly incorporated herein by reference thereto.

### FIELD OF THE INVENTION

The present invention relates to processes for the manipulation of the flavor of chocolate independently of the processes, formulations and ingredient origins used in the preparation of chocolate.

### BACKGROUND TO THE INVENTION

The process of making chocolate is described in “Industrial Chocolate Manufacture and Use”, edited by S. T. Beckett, (Third Edition, 1999, Blackwell Science) the contents of which are incorporated by reference.

Chocolate is generally obtained by mixing sugar and cocoa butter with cocoa liquor or cocoa nibs, followed by refining, conching and tempering. Milk chocolate is prepared in a similar way but with the addition of milk. One traditional method of producing milk chocolate (dry process) is by mixing milk powder together with cocoa liquor or cocoa nibs, sugar, and cocoa butter, followed by refining, conching and tempering. Another traditional method of producing milk chocolate (wet process) is by condensing and drying either liquid milk or milk concentrate together with sugar with or without cocoa liquor normally under vacuum and at elevated temperatures to produce a chocolate crumb powder and then mixing the chocolate crumb powder with cocoa butter, cocoa liquor, followed by refining, conching and tempering. Optionally, the cocoa butter may be partially or totally replaced by direct cocoa butter replacements, stearines, coconut oil, palm oil, butter or any mixture thereof to give substitute chocolate materials which are generally referred to as compound, couvertures or ice cream coatings. In this invention, the term “chocolate” includes standard chocolate as well as substitute chocolate such as compound, couvertures or ice cream coatings.

Local chocolates are often unique and contain flavors that are important for the consumer and it has been known for many years to add flavors to chocolate. This is done for two reasons, firstly, modification or enhancement of the cocoa or dairy flavor, e.g. to give a rounded smoothness to the profile or to create a creamy note, which is usually done by adding up to 0.2% of vanilla, vanillin, ethyl vanillin, etc., and secondly, to impose a different, overriding, dominant but compatible flavor, e.g. by adding orange oil, peppermint oil, strawberry, raspberry, etc.

It is well known that there are a large number of different consumer-recognizable flavor attributes associated with chocolate, however, other than the mere enhancement of the chocolate flavor or a different overriding, dominant flavor, which vary considerably around the world according to local consumer preferences. These flavor attributes of chocolate products are determined by variations in the process and the amounts of the normal ingredients used in chocolate manufacture, e.g. cocoa and milk. These flavor attributes may be, for example, roasted, sweet, bitter, crumb, caramel, fruity, floral, biscuit, bouquet, spicy, scented, baked, bready, cereal, popcorn, malty, astringent and praline. Such flavor attributes are well-known in the cocoa trade where they form part of the vocabulary. Consequently, local chocolates are often unique and contain flavor attributes that are important for the consumer.

Some manufacturers produce chocolate by using chocolate ingredients and a process which only gives one flavor attribute to give a specific house flavor and the manufacturing plants are only able to produce a limited variation around this flavor. However, for a chocolate product containing chocolate and another ingredient, e.g. a chocolate biscuit or a product comprising a centre coated with chocolate, it is important to match the chocolate flavor attribute with the flavor intensity type of the other ingredient. For example, a cooked chocolate flavor attribute is desirable for a chocolate biscuit, a strong cocoa flavor attribute is required to offset a mint flavor intensity type whereas only a mild flavor attribute is required for praline which has a low intensity flavor. It would be very desirable to be able to manipulate the flavor associated with chocolate produced by a single process to obtain a flavor attribute of one's choice by adding the desired flavor attribute to a single chocolate mass irrespective of the process of preparation of the chocolate mass, the formulations and the ingredient origins. This would lead to the operation of a highly flexible chocolate plant. By “flavor attribute” in this invention, we mean a consumer-recognizable flavor attribute associated with chocolate, and not the mere enhancement of the chocolate flavor, e.g. by adding vanilla, or a different overriding, dominant flavor such as peppermint.

We have found, surprisingly, that by removing at least some of the natural flavor from the chocolate ingredients or the chocolate mass and then adding the desired flavor attribute to the chocolate mass, it is possible to manipulate the flavor associated with chocolate of the chocolate by adding the desired flavor attribute to a single chocolate mass irrespective of the process of preparation of the chocolate mass, the formulations and the ingredient origins. Thus a single manufacturing plant will become far more flexible and able to produce a full range of flavors.

### SUMMARY OF THE INVENTION

According to the invention, there is provided a process for manipulating the flavor of a single mass of chocolate which comprises first removing at least some of the natural flavor from the chocolate ingredients or the chocolate mass and then adding a flavor effective amount of a flavor attribute to the chocolate mass. This provides a flavor attribute associated with chocolate and overcomes the variations in chocolate flavor obtained in the manufacture of chocolate using different processing conditions and/or ingredients.

### DETAILED DESCRIPTION OF THE PREFERRED EMBODIMENTS

The chocolate mass to be manipulated may be a standard chocolate such as dark, milk, white chocolate or it may be a compound or ice cream coating. The milk or white chocolate mass may be a crumb chocolate or a non-crumb chocolate. Non-crumb chocolates are preferred in this process as they have less intense flavors and are more easily manipulated.

The natural chocolate flavor as determined by variations in the process and the amounts of the normal ingredients used in the particular chocolate manufacture may be reduced or removed from the chocolate mass, for example, by stripping using the following methods:

a) by pretreating cocoa during or following roasting with water which is later evaporated and takes with it the flavor. The amount of water may easily be determined by those skilled in the art according to requirements but is not usually more than 20% by weight based on the weight of the cocoa and is conveniently from 5% to 10% by weight.

b) adding water to liquid chocolate as it is processed by a high shearing/drying machine, e.g., a Petzomat machine. The amount of water may easily be determined by those skilled in the art according to requirements but is not usually more than 20% by weight based on the weight of the cocoa and is conveniently from 5% to 10% by weight.

c) avoiding the use of commercially available high heat-treated milk powders which possess strong cooked “Maillard” flavors.

d) other known technologies for removing volatiles, such as spinning discs, PDAT reactors (Carle & Montanari) with inert gas, or scraped surface heat exchangers with forced air or vacuum applied.

When adding and removing water during these methods of reducing or removing natural chocolate flavor, care should be taken not to use too much heat otherwise caramelization may occur and hence undesirable or burnt flavor formation, especially for milk chocolate.

It should be understood that these methods of reducing or removing natural chocolate flavor are carried out in addition to the common unit operations carried out during normal chocolate manufacture, but may be a continuation of the normal process, e.g. conching initially removes unwanted acidic flavors, but if extended can produce a very bland chocolate.

By reducing or removing the existing cocoa/dairy flavors from the chocolate mass, it is possible to prepare a base chocolate with a low intensity flavor which may or may not be bland, whatever the original chocolate ingredients or process used, and then add flavor attributes according to the market requirements.

The flavor attributes may be obtained by adding cocoa and/or milk/dairy flavors or by adding non-cocoa/dairy flavors to a single mass, e.g. natural, natural identical, artificial or plant extract flavors.

The amount of flavor attribute added to the chocolate mass may be determined according to requirements and may be a flavor perceptible amount up to 10% by weight. For example, the amount of flavor added may be conveniently from 0.001% to 5%, preferably from 0.01% to 4%, more preferably from 0.1 to 2.5% and especially from 0.2% to 2% by weight based on the weight of the chocolate mass.

The flavor attributes may be any of the following: roasted, sweet, bitter, crumb, caramel, fruity, floral, biscuit, baked, bready, popcorn, cereal, malty, astringent or praline. The flavor attribute may be a single ingredient or a mixture of ingredients, e.g. a bottle flavor or an extracted flavor, or it may be a reaction flavor formed from a mixture of flavor precursors. For example, a crumb flavor attribute may be added to a non-crumb chocolate having a reduced flavor as compared with a normal crumb chocolate in amounts, for example, from 0.1% to 5% and may provide very desirable flavors.

Examples of cocoa/dairy flavor attributes that may be added to the chocolate mass are as follows:

Cocoa and/or chocolate product (i.e., nibs, liquor, cocoa powder, chocolate, cocoa butter, conch mass, etc.) distillates, solvent extracts, CO2 extracts, and a cocoa aroma/flavor obtained by cryogenic aroma capture from aroma gas which evolves during the processing of cocoa, for example, as described in U.S. Pat. No. 6,090,427.

Natural, artificial, plant extract flavors or Nature identical compounded flavors labelled as chocolate, milky, dairy, cream, cocoa, etc., if the name infers chocolate or milky.

Cocoa/chocolate reaction flavors known to those familiar to the art.

Dairy products or biogenerated flavors and/or intermediates in flavor compound generation (hydrolyzed milk fat, cultured products, enzyme generated flavors or intermediates).

Examples of non-cocoa/dairy flavor attributes that may be added to the chocolate mass are as follows:

1) The flavor attribute may be a concentrate formed by adding a mixture of flavor precursors comprising (A) proline, ornithine or protein hydrolysate, and (B) rhamnose, fructose or fucose, to a fat-based medium and heating the mixture to about 100-140° C. for about 10-120 minutes. This flavor attribute may provide caramel and biscuit/cookie attributes to the chocolate. The amount of this flavor attribute added to the chocolate may be from 0.01-5% by weight based on the total weight of the chocolate.

Preferably, the reaction is performed at 100-150° C. for from 10 to 60 minutes, preferably from 115° C. to 135° C. for from 20-40 minutes. The concentration of the flavor precursors may be about 5-250 mM, preferably about 50 mM. Preferably, the fat-based medium is anhydrous milk fat, cocoa butter, lipase hydrolyzed milk fat, cocoa liquor, butter, vegetable oils, medium chain triglycerides (MCT), triacetin, tropical fats and their fractions.

Preferably, the flavor precursors are proline, rhamnose and fructose. Other combinations of flavor precursors include fucose and ornithine. Milk or vegetable protein hydrolysates may be used, and are prepared from milk powder, casein, whey, soy, wheat, cotton, peanut, rice or pea protein isolates or concentrates.

Preferably, the flavor reactions may be performed by the following processes:

i) The fat-based media is heated and the flavor precursors (A) and (B) are dispersed in the melted fat-based medium and reacted under reflux at 125 ° C. This preferably occurs under agitation. In this process, the flavor precursors are added directly in the fat-based medium without any addition of moisture.

ii) The flavor precursors A and B may also be dissolved in alkaline water solution, buffer at pH 5-8 or 5-50% potassium carbonate solution to form a flavor precursor solution or suspension which is then added at less than 1.5% level (w/w) to the melted fat and reacted with agitation under reflux at 125 ° C. Preferably, pH of the mixture before the reaction is 8.

iii) The flavor precursors A and B may also be dissolved in alkaline water solution, buffer pH 5-8 or 0.1-50% potassium carbonate solution. The flavor precursor solution or suspension generated is added at 1.5-5% level (w/w) to the melted fat-based medium, the reaction mixture thus obtained is heated under agitation for 10-20 minutes from 100° C. to 125 ° C., without closing the vessel to evaporate most of the moisture, and the remaining 10-20 minutes of the reaction is performed at 125° C. under agitation and reflux. Preferably, the total reaction time is about 30 minutes. Preferably, pH of the mixture before reaction is 8.

Preferably, rhamnose and proline flavor precursors were used which were dissolved in 5% buffer (100 mM Na-phosphate pH 8) and added to the heated fat-based medium, preferably anhydrous milk fat. The reaction mixture was heated for 10 minutes from 100° C. to 125° C. without closing the reactor to evaporate most of the water. The remaining 20 minutes of the reaction was performed at 125° C. under reflux in the fat-based medium. This process allows maximum 4-hydroxy-2,5-dimethyl-3(2H)-furanone concentration to be obtained. Thus, the present invention has surprisingly positive results in the generation of caramel and biscuit flavor attributes using fat-based media as compared to classical aqueous systems.

Proline was used as amine flavor precursor, as proline is a precursor for caramel as well as biscuit/bread/roast type aroma volatiles. The reaction between proline and rhamnose in a fat-based medium produces a range of flavor active compounds. 4-hydroxy-2,5-dimethyl-3(2H)-furanone and 2-acetyl-1-pyrroline which are involved in caramel and biscuit/bread/roast flavor attributes respectively, were used as chemical markers in the described invention. 4-hydroxy-2,5-dimethyl-3(2H)-furanone was the major compound in most of the reaction flavor products. The rich and balanced flavor attribute was most likely achieved by a mixture of several compounds generated in the reaction. Examples of other compounds in the reaction mixture were 3-hydroxy 2-butanone (acetoine), 1-hydroxy 2-propanone (acetol), 5-methyl furfural, 2-hydroxy 3-methyl 2-cyclopenten-1-one (corylone) and 4-acetoxy 2,5-dimethyl-3(2H)-furanone. Surprisingly, it was found that proline resulted in the highest level of 4-hydroxy-2,5-dimethyl-3(2H)-furanone accumulation in fat-based reaction systems. However, the aroma of the flavor concentrates may not be linked or limited to any of the compounds mentioned.

Addition of 5% buffer, pH 8 facilitated improved flavor precursor solubility and subsequent high 4-hydroxy-2,5-dimethyl-3(2H)-furanone generation and intense caramel flavor of the fat mixture. However, reduction of the aqueous phase to, for example, 1.5% can be beneficial to avoid the first stage of the reaction including moisture evaporation. It is possible to perform the reaction without any addition of aqueous solution along with the flavor precursors. In particular, this method is preferred in order to stabilize certain aroma compounds directly in the fat phase.

All fat-based reactions with rhamnose resulted in intense caramel and biscuit/cookie flavor attributes. Reactions with fructose, which is a cheaper sugar flavor precursor, resulted in substantially lower amount of 4-hydroxy-2,5-dimethyl-3(2H)-furanone. The 4-hydroxy-2,5-dimethyl-3(2H)-furanone level as well as the caramel flavor could be increased by increasing the ratio of fructose to proline. Reactions in anhydrous milk fat with 50 mM proline and 100 mM fructose resulted in a further increase in 4-hydroxy-2,5-dimethyl-3(2H)-furanone level and a strong caramel and biscuit/cookie flavor attribute. Thus, fructose and proline can also be used as flavor precursor combination in fat-based flavor reaction.

A further aspect of this invention is directed to the use of the flavor concentrates as described above in the manufacture of chocolate (including compound) using 0.01-5%, preferably 0.5% by weight of the flavor concentrate, based on the weight of the total chocolate. Preferably, the flavor concentrate is incorporated directly into the chocolate. As the flavor concentrate is generated directly in chocolate compatible ingredients, no drying or extraction is necessary before incorporation into the chocolate mass. These flavor concentrates impart caramel and/or cookie/biscuit note in the chocolate. The flavor concentrate can be added alone or in combination with other flavors.

According to a yet further aspect of this invention there is provided a chocolate product with modified flavor characteristics comprising the flavor concentrate as described above. Such chocolate products include milk, dark and white chocolate as well as compound coatings for use for example in bars or ice-cream coatings.

2) The flavor attribute may be an enzymatic hydrolysate of cocoa polysaccharides, e.g. from the cocoa shell, e.g. pectin. Such flavors may provide caramel, biscuit or toffee flavor attributes and may be incorporated in an amount below 5% into the chocolate According to one aspect of this invention provides a cocoa shell pectin extract having a rhamnose content of approximately 5 mM to approximately 100 mM. According to a further aspect this invention provides a process for the preparation of a cocoa shell pectin hydrolysate having a rhamnose content of approximately 5 mM to approximately 100 mM comprising the chemical and/or enzymatic hydrolysis of cocoa shell pectin. According to a still further aspect this invention provides a cocoa shell pectin hydrolysate having a rhamnose content of approximately 5 mM to approximately 100 mM. According to another aspect this invention provides a flavor concentrate comprising cocoa shell pectin hydrolysate according to the present invention. According to yet another aspect this invention provides the use of a cocoa shell pectin hydrolysate according to the present invention as a flavor concentrate for food.

It has surprisingly been found that the pectin from cocoa shell contains an unusually high rhamnose content of approximately 5 to 7% by weight rhamnose based on the dry weight of pectin. Thus, the present invention provides a new rich source of rhamnose which can be used to generate new flavor profiles when added to food products.

The preparation of cocoa shell pectin extracts is carried out using a standard procedure for extracting pectins.

Hydrolysis of the cocoa shell pectin extracts is carried out by chemical and/or enzymatic degradation. Preferably, the following enzymes and chemicals are used, acetic acid, hydrochloric acid, pectinolytic enzymes (polygalacturonase, rhamnogalacturonases, pectin lyase, arabinase, galactanase) in association with esterases such as rhamnogalacturonan acetylesterase or with exoglycosidases such as beta-galactosidase, arabinofuranosidase and fucosidase. Mixtures of these enzymes can be found in commercial enzyme preparations produced by fermentation of microorganisms on suitable complex media.

Any suitable reaction medium for flavor generation may be used including, aqueous solutions, ethanol, propylene glycol, glycerol, or a fat-based medium such as, anhydrous milk fat, cocoa butter, cocoa liquor, compound fat, lipase hydrolyzed milk fat, butter, vegetable oils, medium chain triglyceride, triacetin or tropical fats and their fractions.

The cocoa shell pectin hydrolysate can be reacted with individual free amino acids, peptides, protein hydrolysates or mixtures of amine flavor precursors.

Preferably, the preparation of flavor concentrates involves the addition of cocoa shell pectin hydrolysate to a fat-based medium, most preferably milk fat, together with proline and a phosphate buffer at pH 8, 125° C. for approximately 60 minutes. Preferably, the cocoa shell pectin hydrolysate and proline flavor precursors used are dissolved in 5% buffer (100 mM Na-phosphate pH 8) and are added to the heated fat-based medium, preferably anhydrous milk fat. The reaction mixture is heated for 10 minutes from 100° C. to 125° C. without closing the reactor to evaporate most of the water. The remaining 20 minutes of the reaction is performed at 125° C. under reflux in the fat-based medium. Addition of 5% buffer, pH 8 facilitates improved flavor precursor solubility and subsequent high 4-hydroxy-2,5-dimethyl-3(2H)-furanone generation and intense caramel flavor attribute of the fat mixture.

The rhamnose containing cocoa shell extract may be used in different flavor reactions including applications for sweet (e.g. caramel, biscuit, buttery, toffee, fruity, malty, roasted) and savory or culinary products. The flavor concentrates produced can be incorporated into foods such as confectionery products, chocolate, beverages, ice-cream, biscuits and baked products, savory and culinary products. It may be used in chocolate manufacture including the manufacture of milk, dark and white chocolate as well as compound chocolate for use in, for example, bars and ice-cream coatings.

3) A malty flavor attribute may be obtained by acid treatment of a cocoa liquor followed by a protease treatment.

According to one aspect of this invention there is provided a process for the production of enzymatically-treated unfermented cocoa liquor comprising acid treatment of the cocoa liquor followed by protease treatment. Another aspect of this invention is the use of enzymatically hydrolyzed cocoa liquor in generation of process flavor reactions. A still further aspect of this invention is a chocolate or compound product produced using a process flavor made using the enzymatically treated cocoa liquor.

The acid treatment is performed as an in-vitro fermentation step to activate the endogenous enzyme system and to utilize the endogenous proteases in cocoa. The subsequent protease treatment is applied to obtain high degree of hydrolysis (DH) and a high level of reactive free amino acids and peptides. This treatment is used to increase the flavor precursor pool during chocolate flavor reactions. Cocoa hydrolysates produced in accordance with this process are used as an ingredient in process flavor reactions. The cocoa liquor hydrolysates may be used alone or together with other ingredients or flavor precursors, such as amino acids, peptides or sugars, as a source of amine flavor precursors in process flavor reactions.

The cocoa liquor may be fully or partially defatted prior to use. Such use of fully or partially defatted cocoa liquor enables flexible use of different cocoa materials as a base ingredient in process flavor reaction. Preferably, the acid treatment involves decreasing the pH of the unfermented cocoa liquor to approximately pH 2 to 5, most preferably to pH 4. Preferably, acetic acid, citric acid or phosphoric acid is used at a concentration of from about 0.01 to about 1 M. Protease treatment involves the incubation of the unfermented cocoa liquor mixture with an endoprotease and/or exoprotease. Preferably, from 0.1% to 5% protease based on dry weight of cocoa is used. Most preferably, the cocoa is incubated with 0.1 M acetic acid at 50 ° C. for 6 hours, followed by treatment with 2% protease, based on dry weight of cocoa, for 18 hours at 50 ° C. Treatment times for both the acid and protease treatment are preferably from 1 to 48 hours.

The treated cocoa liquor can be used in process flavor reactions. In the flavor reactions generation of a balanced cocoa flavor is not the only criterion. The introduction of other attributes, for example caramel, biscuit, fruity and malt are also of interest. Thus, another objective was to produce a cocoa ingredient with a maximum degree of hydrolysis for use in chocolate flavor reactions.

The process flavor attributes made using the treated cocoa liquor can be used in the manufacture of standard chocolate, compound chocolate, ice-cream coatings and in other food products, desserts and drinks.

4) A caramel flavor attribute may be provided by the reaction of skimmed milk powder in a fat such as milk fat, cocoa butter, cocoa butter substitute, cocoa liquor, vegetable fats or combinations of fats at an elevated temperature. The amount of skimmed milk powder may be from 0.5% to 50% by weight based on the weight of the mixture. The temperature of the reaction may be from 100° C. to 150° C. and preferably from 115° C. to 135° C. The duration of the reaction may be from 15 minutes to 2 hours and preferably from 30 to 90 minutes. The caramel flavor attribute may be incorporated into chocolate from which the natural flavor has been reduced or removed in an amount from 0.1% to 5% and preferably from 0.5% to 2% by weight based on the weight of the chocolate.

The present invention also provides a process for manipulating the flavor of a single mass of chocolate which comprises first reducing or removing the natural flavor from the chocolate ingredients or the chocolate mass and adding an effective amount of a flavor attribute to the chocolate mass independently of the chocolate mass processes, formulations and ingredient origins.

The flavor attribute may be added to any of the ingredients of the chocolate mass and at any stage of the chocolate-making process before tempering. A major advantage of the invention is the production of chocolate and compound coatings with a particular flavor attribute independently of its assets, processes, formulations and ingredient origins.

The invention permits the development of chocolate products with a global flavor, optimization of asset utilization, cost reduction, recipe flexibility and development of products with particular flavors that are preferred by the local consumers.

### EXAMPLES

The following Examples further illustrate the present invention.

### Example 1

The flavor reactions were performed in a round bottom 3-necked stirred reactor with temperature control. Anhydrous milk fat (80 g) was melted in the reactor and heated to 125° C. The flavor precursors, rhamnose (50 mM) and proline (50 mM), were added directly with the milk fat or added separately when the temperature of the milk fat had reached 125 ° C. Rhamnose and proline were reacted in the milk fat for 60 min at 125 ° C. under reflux. The reacted material was allowed to cool to room temperature and stored at 4° C. or room temperature. The flavor attributes were incorporated at 0.5% level of addition into a chocolate mass.

Incorporation into compound chocolate:

5% by weight of water is added to liquid compound chocolate and processed by a high shearing/drying Petzomat machine to remove some of the natural flavor and give a bland compound chocolate. One gram of the reaction flavor attribute was added to 199 grams of the treated completely melted compound mass, thoroughly mixed by hand, and molded into 20 gram bars. Following cooling, bars were demolded and allowed to equilibrate to room temperature for at least 4 hours. The samples were allowed to equilibrate at 15 ° C. for 1-30 days before tasting.

Incorporation into white and milk chocolate:

5% by weight of water is added to separate samples of liquid white and milk chocolate and each sample is processed by a high shearing/drying Petzomat machine to remove some of the natural flavor and give samples of bland chocolate.

One gram of the reaction flavor attribute was added to 199 grams of each of the completely melted chocolate masses and mixed manually at 50° C. to homogenize the samples, followed by precrystallization and molding into 5 g bars. Following cooling, bars were demolded and allowed to equilibrate to room temperature for at least 4 hours. The samples were allowed to equilibrate at 15° C. for 1-30 days before tasting.

The chocolate samples were evaluated by blind tasting with 6-9 trained panelists. All samples were compared to a reference chocolate mass without any flavor manipulation. Incorporation of the fat-based flavor attribute resulted in strong enhancement of attributes such as caramel, biscuit, and cookie in the chocolate mass.

### Example 2

A flavor reaction was performed according to example 1, except that 1.5% of alkaline water (Stock solution: 4 drops of 50% NaOH in 20 ml water) was added along with the rhamnose and proline. This approach facilitated the reactions at basic pH and increases the solubility of the precursors. Incorporation of 0.5% of the fat-based flavor attribute into chocolate, as described in example 1 which had previously been processed by a high shearing/drying Petzomat machine to remove some of the natural flavor and give a bland chocolate, resulted in attributes such as caramel, biscuit and cookie. Strongest caramel flavor was achieved after 30 min of reaction.

### Example 3

A flavor reaction was performed according to example 1, except that the rhamnose and proline flavor precursors were dissolved in 100 mM Na-phosphate buffer, pH 8 and added when the milk fat had reached a temperature of 100 ° C. This approach facilitated the reactions at basic pH and increases the solubility of the precursors. The mixture was heated without closing the reactor until most of the moisture had evaporated and the product temperature had reached 125 ° C. The reaction was continued under reflux at 125 ° C. Total reaction time was 30-60 min. Incorporation of 0.5% of the fat-based flavor attribute into chocolate, as described in example 1, which had previously been processed by a high shearing/drying Petzomat machine to remove some of the natural flavor and give a bland chocolate, resulted in attributes such as caramel, biscuit and cookie. Strongest caramel flavor was achieved after 30 min of reaction. The strong caramel flavor was correlated to high 4-hydroxy-2,5-dimethyl-3(2H)-furanone level.

### Example 4

A flavor reaction was performed according to example 1, except that the flavor precursors were 50 mM fructose and 50 mM proline. Incorporation of 0.5% of the fat-based flavor attribute into chocolate having a bland flavor, which had previously been processed by a high shearing/drying Petzomat machine to remove some of the natural flavor, resulted in attributes such as caramel and biscuit. Strongest biscuit flavor was achieved after 60 min of reaction. Fructose/proline reaction in anhydrous milk fat resulted in the highest accumulation of 2-acetyl-1-pyrroline. The level of 4-hydroxy-2,5-dimethyl-3(2H)-furanone was lower as compared to reactions with rhamnose.

### Example 5

A flavor reaction was performed according to example 4, except that the flavor precursors were 100 mM fructose and 50 mM proline. Incorporation of 0.5% of the fat-based flavor attribute into chocolate having a bland flavor, which had previously been processed by a high shearing/drying Petzomat machine to remove some of the natural flavor, resulted in attributes such as caramel, cookie and biscuit. The caramel attribute was enhanced by increasing the fructose concentration from 50 to 100 mM.

### Example 6

A flavor reaction was performed according to example 4, except that the flavor precursors were 1% fructose and 1% casein hydrolysate. The casein hydrolysate was prepared by standard techniques using Flavourzyme 1000 L (fungal protease/peptidase mixture from Novo Nordisk, Denmark). Hydrolysis was performed at 50° C. using 1% enzyme by weight of protein content to achieve approximately 50% degree of hydrolysis. Incorporation of 0.5% of the fat-based flavor attribute into chocolate, which had previously been processed by a high shearing/drying Petzomat machine to remove some of the natural flavor, resulted in an increase in the caramel attribute.

### Example 7

Ornithine, which is a well known precursor of biscuit/bread/baked impact compounds was also reacted in the milk fat system. A flavor reaction was performed according to example 2, except that the flavor precursors were 50 mM rhamnose and 50 mM ornithine. Incorporation of 1 % of the fat-based flavor attribute into chocolate with a bland flavor, made from cocoa which had been pretreated during roasting in the presence of 10% by weight of water which was later evaporated taking with it the flavor, resulted in an increase in the caramel attribute. Although a flavor impact was achieved with ornithine, it was less pronounced than with proline.

### Example 8

A flavor reaction was performed according to example 1, except that the flavor precursors were 50 mM fucose and 50 mM proline. Incorporation of 1% of the fat-based flavor attribute into chocolate, made from cocoa which had been pretreated during roasting in the presence of 7.5% by weight of water which was later evaporated taking with it the flavor, resulted in an increase in the caramel and biscuit attributes.

### Example 9

Cocoa butter can also be used as reaction medium. A flavor reaction was performed according to example I except that the reaction medium was cocoa butter. The flavor precursors were 50 mM rhamnose and 50 mM proline. Incorporation of 1% of the fat-based flavor attribute into chocolate having a bland flavor, which had previously been processed by a high shearing/drying Petzomat machine to remove some of the natural flavor, resulted in an increase in the caramel and biscuit attributes. Again, the combination of proline/rhamnose in presence of 5% buffer, pH 8 was proven optimal to obtain high 4-hydroxy-2,5-dimethyl-3(2H)-furanone concentration. Although the 4-hydroxy-2,5-dimethyl-3(2H)-furanone concentration was high in these samples, the panelists perceived lower caramel as compared to chocolate samples prepared with reaction flavors in milk fat. Thus, milk fat seems to contribute to the flavor when incorporated in the final chocolate.

### Example 10

A flavor reaction was performed according to example 3 except that the reaction medium was cocoa liquor. The flavor precursors were 50 mM rhamnose and 50 mM proline. Incorporation of 1% of the fat-based flavor attribute into chocolate having a bland flavor, which had previously been processed by a high shearing/drying Petzomat machine to remove some of the natural flavor, resulted in an increase in the caramel and biscuit attributes.

### Example 11

A flavor reaction was performed according to example 5 except that the reaction medium was lipase hydrolyzed milk fat. Hydrolysis was performed with an immobilized lipase, Lipozyme RM IM from Novo Nordisk, Denmark. The flavor precursors were 50 mM proline and 100 mM fructose. Incorporation of 0.2% of the fat-based flavor attribute into chocolate, which had previously been processed by a high shearing/drying Petzomat machine to remove some of the natural flavor, resulted in an increase in the caramel, biscuit, and cheesy attributes.

### Example 12

Enzyme-treated 1 M KOH-soluble extract from cocoa shell Preparation of 1M KOH-soluble extract:

10 g of cocoa shell was extracted in 200 ml of 1 M KOH containing 20 mM NaBH₄ for 4 hours at room temperature. The suspension was centrifuged and the supernatant neutralized with acetic acid, dialyzed and then freeze dried. The composition of the extracted polysaccharide is shown in Table 1.

TABLE 1
Composition of 1 M KOH-soluble cocoa shell fraction

| | Rha | Fuc | Ara | Xyl | Man | Gal | Glc | UA* | Total |
|---|---|---|---|---|---|---|---|---|---|
| μg/mg | 33.2 | 1.6 | 13.9 | 22.1 | 25.3 | 93.4 | 42.5 | 290 | 522 |
| Mole % | 7.1 | 0.3 | 3.3 | 5.2 | 4.7 | 17.5 | 7.9 | 54.0 | — |

Enzymatic treatment:

An aliquot of the extract obtained (1 g in 50 ml of distilled water) was hydrolyzed with 0.25 ml of Viscozyme L, a multi-enzyme complex produced from Aspergillus aculeatus (Novozymes A/S, Denmark), at 40° C. for 16 hours with stirring. The pH during incubation was 4.9. The mixture was then freeze dried. Determination of free rhamnose in the final product indicated that 18.2% of rhamnose was liberated from the 1 M KOH-soluble cocoa shell fraction by enzymatic treatment. The results are shown in Table 2.

TABLE 2

| | Experimental | Rha (μg) | Powder (mg) | Rha(%) |
|---|---|---|---|---|
| Total | 2 M TFA - 120° C. - | 155 | 3.1 | 5.0 |
| | 2 h | | | |
| Liberated | Soluble in 70% EtOH | 246 | 27 | 0.91 |
| by | | | | |
| Viscozyme | | | | |
| | | | Yield (%) | 18.2 |

### Example 13

Production of acid hydrolysate from Na₂CO₃-soluble pectin of cocoa shell

11.5 g of sodium carbonate extracted pectin was hydrolyzed in 575 ml 2 M H Cl by autoclaving at 120° C. for 1 h. The hydrolysate was filtered to remove black sediment and then dried. When the volume was reduced to about 50ml acetic acid was added and the solution dried down and held under vacuum for 3 days over NaOH pellets to remove residual acid. Water was added and the solution was evaporated to dryness and the flask was dried again over P₂O₅ and NaOH pellets. The drying down process was repeated twice.

The dried material weighed 9.6 g. It was dissolved in 100 ml water and half was adjusted to pH 5.8 with 2-3 ml of 2.5 M NH₄OH and filtered through glass fiber paper to remove undissolved residue and passed through a column of QAE Sephadex which had been converted to the formate form. The hydrolysate in the column was eluted with 350 ml water. The neutral fraction, which was not retained on the column and the acidic fraction (recovered by eluting the column with 350 ml 10% formic acid) were each dried down on the rotovap and the latter fraction put over NaOH and P₂O₅ under vacuum overnight. Table 3 shows the composition of the hydrolysate fractions prepared.

| | Weight of fractions: |
|---|---|
| Original Na₂CO₃-sol pectin | 11.5 g |
| Insoluble fraction after hydrolysis | 1.4 g |
| Total soluble acid hydrolysate | 8.4 g |
| Neutral fraction (from half the hydrolysate) | 1.4 g |
| Acidic fraction (from half the hydrolysate) | 2.4 g |

TABLE 3
Composition of hydrolysate fractions (μg/mg)

| | Rha | Fuc | Ara | Xyl | Man | Gal | Glc | UA | Total |
|---|---|---|---|---|---|---|---|---|---|
| Total | 34.0 | 0.3 | 3.2 | 1.0 | 9.7 | 33.9 | 10.1 | 210.4 | 303 |
| Neutral | 68.9 | 0.8 | 4.6 | 1.6 | 17.2 | 59.6 | 18.3 | 189.0 | 358 |
| Acid | 2.9 | 4.3 | 0.7 | 0.9 | 1.3 | 4.6 | 2.8 | 351.0 | 369 |

### Example 14

Use of hydrolysates in the preparation of reaction flavors and incorporation into white chocolate

The hydrolysates prepared in accordance with examples 12 and 13, including the total hydrolysate and the hydrolysate purified by cation exchange were incorporated into a reaction flavor comprising 8.5 g milk fat, Ig shell hydrolysate (5 mM free rhamnose), 50 mM Proline, 5% phosphate buffer at pH 8, 125° C. for 60 minutes. The reaction flavor attribute thus obtained was then incorporated into white chocolate having a bland flavor, which had previously been processed by a high shearing/drying Petzomat machine to remove some of the natural flavor, at a level of 1-1.5% by weight based on the total mentioned chocolate in accordance with the afore-mentioned recipe and subjected to sensory evaluation. Sensory evaluation of the white chocolate produced using the hydrolysates of examples 12 and 13 showed an increased caramel flavor.

### Example 15

Use of hydrolysates in the preparation of reaction flavors and incorporation into milk chocolate

The total hydrolysate and the hydrolysate prepared by cation exchange prepared in accordance with example 13 were incorporated into reaction flavors A and B comprising

A) 8.5 g milk fat, 2.28 g total shell hydrolysate (50 mM free rhamnose), 50 mM Proline, 5% phosphate buffer at pH 8, 125° C. for 60 minutes; and

B) 10.5 g milk fat, 1.11 g shell hydrolysate purified by cation exchange (50 mM free rhamnose), 50 mM Proline, 5% phosphate buffer at pH 8, 125° C. for 60 minutes.

Reaction flavor attributes A and B were then incorporated into milk chocolate which had previously been processed by a high shearing/drying Petzomat machine to remove some of the natural flavor, at a level of 3% by weight based on the total mentioned chocolate in accordance with the afore-mentioned recipe and subjected to sensory evaluation. Sensory evaluation of both milk chocolates A and B prepared showed an increased caramel flavor.

### Example 16

Use of enzymatically treated cocoa liquor in reaction flavors:

A reference cocoa reaction flavor was prepared by reacting 0.8% Leu, 1.45% Phe, 0.8% Val, 1.5% Fructose, 1.5% water (4 drops of NaOH in 20 ml water) and 94% propylene glycol at 125° C. for 60 min under reflux. Reaction flavors, prepared with cocoa hydrolysates were generated by replacing the amino acids with 1% lyophilized hydrolysate. Tasting was performed on a 0.1% solution in 1% sucrose. The reaction flavors produced with cocoa hydrolysates were tasted and compared against the reference.

The following enzyme treatments were investigated: 24 h and 6 h in-vitro fermentation/Flavourzyme treatment, and 24 h and 6 h in-vitro fermentation (only endogenous enzyme system).

Reaction flavor attributes prepared with enzyme-treated liquor exhibited stronger cocoa flavor compared to a control prepared with untreated unfermented/unroasted cocoa liquor. In particular, the reaction flavor attributes produced with liquor that was treated by only in-vitro fermentation seemed strongest in cocoa flavor.

The reaction flavor attributes generated with 1% cocoa liquor hydrolysates in PG do not contain similar amount of reacting amino groups as in the amino acid reference. The reference is prepared with 0.8% Leu, 1.45% Phe, 0.8% Val, 1.5% fructose, whereas the reaction mixtures with cocoa hydrolysates contains substantially lower level of free amino groups (10-15% protein, DH 10-30). Thus, the amount of reactive amine flavor precursors can be increased substantially by increasing the proportion of hydrolyzed cocoa liquor.

The cocoa hydrolysates, described in this example, can be used as a base ingredient in chocolate process flavor reactions to introduce a base or specific note for a full body chocolate/cocoa flavor concentrate by adding 2% by weight of the concentrate to a melted chocolate mass having a bland flavor, which had previously been processed by a high shearing/drying Petzomat machine to remove some of the natural flavor,

### Example 17

10 parts of skimmed milk powder and 90 parts of milk fat are blended and reacted at 125° C. for 60 minutes to give a caramel reaction flavor attribute.

Incorporation of 1% of the above caramel flavor attribute into chocolate with a bland flavor, made from cocoa which had been pretreated during roasting in the presence of 10% by weight of water which was later evaporated taking with it the flavor, resulted in an increase in the caramel attribute.

### Example 18

A milk chocolate compound coating was first prepared according to the following general composition:

| Component | Weight Percentage |
|---|---|
| Sucrose | 50.00 |
| Non fat dry milk (NFDM) | 13.78 |
| Cocoa | 6.00 |
| Vegetable Fat | 30.00 |
| Vanillin | 0.02 |
| Lecithin | 0.2 |

The liquid compound chocolate composition is processed with the addition of 5% of water by a high shearing/drying Petzomat machine to remove some of the natural flavor and give a bland compound chocolate.

One flavor compound was added to the milk chocolate compound coating and evaluated by a descriptive panel trained in tasting chocolate and cocoa:

Concentration (ppm)

| Compound | 2174-112a | 2174-112b |
|---|---|---|
| 2,5-dimethyl-4-hydroxy-3(2H)-furanone | 0 | 10 |

Results showed that addition of 2,5-dimethyl-4-hydroxy-3(2H)-furanone at 10 ppm to the compound coating increased significantly the caramelized sugar (p-value=0.0112) and cocoa (p-value=0.0075) attributes relative to the unflavored control.

### Example 19

Volatile cocoa aroma compounds from a cocoa nib grinder were captured and condensed using technology described in U.S. Pat. No. 6,090,427. A portion of this residue was added to a chocolate compound coating processed in a similar way to the one described in example 18 to give a bland flavor.

Concentration (%)

| Compound | 2176-17 | 2174-53c |
|---|---|---|
| Grinder Gas Residue | 0 | 0.15 |

Results showed that addition of the grinder gas residue to the compound coating increased significantly the Fruity attribute (p-value=0.0016) relative to the unflavored control.

### Example 20

One flavor compound was added to a milk chocolate compound coating similar processed in a similar way to the one described in example 18 to give a bland flavor.

Concentration (ppm)

| Compound | Unflavored | 2150-36C |
|---|---|---|
| Phenethyl alcohol | 0 | 20 |

When evaluated blind against the unflavored control by panelist experience in chocolate tasting, the sample with added phenethyl alcohol was considered to be higher in a floral (rose-like) attribute by all panelists.

What is claimed is:

1. A process for manipulating the flavor of a single mass of chocolate which comprises first reducing or removing natural flavor from chocolate ingredients or the chocolate mass and then adding a flavor effective amount of a flavor attribute to the chocolate mass to thus manipulate the flavor of the mass.

2. The process according to claim 1, wherein the flavor attributes are provided by adding a cocoa, milk/dairy or non-cocoa/dairy flavor to the mass of chocolate.

3. The process according to claim 1, wherein the flavor attributes provide one of more of the following attributes: roasted, sweet, bitter, caramel, fruity, floral, biscuit, baked, crumb, bready, popcorn, cereal, malty, astringent or praline.

4. The process according to claim 1, wherein the natural chocolate flavor is reduced or removed from the chocolate mass by pretreating cocoa during or following roasting with water followed by evaporating the water that takes with it the flavor.

5. The process according to claim 1, wherein the natural chocolate flavor is reduced or removed from the chocolate mass by adding water to liquid chocolate as it is processed by a high shearing and drying machine.

6. The process according to claim 2, wherein the cocoa/dairy flavor attributes added to the chocolate mass are cocoa or chocolate products, distillates, solvent extracts, C02 extracts, or a cocoa aroma/flavor obtained by cryogenic aroma capture from aroma gas which evolves during the processing of cocoa, or other natural plant extracts, an artificial or nature-identical compounded flavor labeled as chocolate, milky, dairy, cream, cocoa, cocoa/chocolate reaction flavors, a dairy product extract or a biogenerated flavor.

7. The process according to claim 2, wherein the non-cocoa/dairy flavor attribute added to the chocolate mass is a concentrate formed by adding a mixture of flavor precursors comprising:
(A) proline, ornithine or protein hydrolysate, and
(B) rhamnose, fructose or fucose, to a fat-based medium and heating the mixture to about 100-140° C. for about 10-120 minutes.

8. The process according to claim 2, wherein the non-cocoa/dairy flavor attribute added to the chocolate mass is a Maillard reaction product between defined mixtures of amino acids and sugars in chocolate compatible fat systems, which are roasted using cocoa liquor technology in the presence or absence of water.

9. The process according to claim 2, wherein the non-cocoa/dairy flavor attribute added to the chocolate mass is an enzymatic hydrolysate of cocoa polysaccharides.

10. The process according to claim 2, wherein the non-cocoa/dairy flavor attribute added to the chocolate mass is a malty flavor obtained by acid treatment of a cocoa liquor followed by a protease treatment.

11. The process according to claim 3, wherein the flavor attribute is added as a crumb flavor attribute to a non-crumb chocolate mass in an amount of from 0.1% to 5%.

12. The process according to claim 2, wherein the flavor attribute is a caramel flavor attribute provided by the reaction of skimmed milk powder in a fat system at an elevated temperature sufficient to provide a caramel flavor.

13. A process for manipulating the flavor of a single mass of chocolate which comprises first reducing or removing natural flavor from chocolate ingredients or the chocolate mass and then adding a flavor effective amount of a flavor attribute to the chocolate mass independently of the chocolate mass processes, formulations and ingredient origins.

14. A process for manipulating the flavor of chocolate produced by a single process to obtain a desired flavor which comprises first reducing or removing natural flavor from the chocolate ingredients or the chocolate mass and then adding a flavor effective amount of an appropriate flavor attribute to the chocolate mass.

15. A process for the preparation of chocolate having a flavor attribute associated with chocolate other than chocolate flavor enhancement or an overriding, dominant flavor that is different than chocolate and which flavor attribute overcomes variations in chocolate flavor obtained in the manufacture of chocolate using different processing conditions or by added ingredients which comprises first reducing or removing natural flavor from the chocolate ingredients or the chocolate mass and then adding a flavor effective amount of an appropriate flavor attribute to the chocolate mass.

16. A chocolate product containing a flavor effective amount of a flavor attribute associated with chocolate other than chocolate flavor enhancement or an overriding, dominant flavor that is different than chocolate and which flavor attribute overcomes variations in chocolate flavor obtained in the manufacture of chocolate using different processing conditions or ingredients.

17. A chocolate product containing a flavor effective amount of a flavor attribute effective to provide roasted, sweet, bitter, crumb, caramel, fruity, floral, biscuit, baked, bready, popcorn, cereal, malty, astringent or praline attributes.

18. A chocolate product obtainable form the process of claim 13.

19. A chocolate product obtainable form the process of claim 14.

20. A chocolate product obtainable form the process of claim 15.

21. A method of providing a specific house flavor in a chocolate however manufactured which comprises first reducing or removing natural flavor from the chocolate ingredients or the chocolate mass and then adding a flavor effective amount of an appropriate flavor attribute to the chocolate mass to provide the specific house flavor.

22. The method according to claim 21 which provides the benefits of optimization of asset utilization, cost reduction and recipe flexibility.

23. A method of providing a specific consumer-recognizable flavor associated with chocolate, other than chocolate flavor enhancement or an overriding, dominant flavor that is different than chocolate, in a chocolate however manufactured which comprises first reducing or removing the natural flavor from the chocolate ingredients or the chocolate mass and then adding a flavor effective amount of an appropriate flavor attribute to the chocolate mass.

24. The method according to claim 22 which provides the benefits of optimization of asset utilization, cost reduction and recipe flexibility.

25. A process for the production of chocolate which comprises removing natural flavor from a chocolate mass and then adding a flavor effective amount of an appropriate flavor attribute to the chocolate mass to provide the benefit of a chocolate having a particular desired flavor independently of assets, processes, formulations and ingredient origins.
